(19) United States
(12) Patent Application Publication
(10) Pub. No.: US 2005/0285834 A1
(43) Pub. Date: Dec. 29, 2005

(54) Color display apparatus and semiconductor device therefor

(75) Inventor: Kenichi Nakata, Kyoto (JP)

Correspondence Address: KEATING & BENNETT, LLP, 8180 GREENSBORO DRIVE, SUITE 850, MCLEAN, VA, 22102, US

(73) Assignee: Rohm Co., Ltd.

(21) Appl. No.: 11/166,402

(22) Filed: Jun. 24, 2005

(30) Foreign Application Priority Data
Jun. 28, 2004 (JP) 2004-189795

(51) Int. Cl. G09G 3/36

(52) U.S. Cl. 345/88

(57) ABSTRACT

One frame of a color image data is resolved into three frames of R, G, and B colors, which are displayed in sequence. In synchronism with the R, G, B frames, a power supply voltage for displaying each of the three frames is altered to predetermined levels set for the respective frames. Output voltage data for determining the voltage levels for red-, green-, and blue-frame are stored in rewritable forms, which are provided to the power supply circuit so that its output voltage is equilibrated to a reference voltage based on that output voltage data provided. The invention enables suppression of color temperature deviation due to variations in transmissivity of color filters while setting a common gradation level for the R, G, an B frames.

### FIELD OF THE INVENTION

This invention relates to a display apparatus, especially a liquid crystal display, for displaying a picture using three-primary color image data. The invention also relates to a semiconductor device for use in such display apparatus.

### BACKGROUND OF THE INVENTION

In recent years lightweight thin display apparatuses are in strong demand along with the popularization of lightweight thin personal computers and TV sets. To meet such demands in different fields, in place of cathode-ray tubes, various flat panel display apparatuses such as a liquid crystal display (LCD) have been developed.

An LCD has two substrates sandwiching between them a liquid crystal material, to which an electric field is applied. A desired image can be displayed on the LCD by controlling the intensity of the electric field at each pixel to vary the degree of polarization of, and hence the amount of transmitting light through, the liquid crystal at that pixel. In a color LCD, there are provided red (R), green (G), and blue (B) pixels, which are provided with a red (R), a green (G), and a blue (B) color filter, respectively, arranged in such a way that white is obtained when R, G, and B pixels have their maximum luminance.

However, white color can become reddish or bluish for example. That is, the color temperature can be deviated, mainly due to variations in transmissivity of each color the color filters.

Such color transmissivity deviation can be suppressed by setting gradation levels of R, G, and B color images independently (patent JPA Laid Open 2003-29724).

However, gradation of R, G, and B color images is normally performed using one common IC chip. In order to set independent gradation levels for R, G, and B images, three IC chips are required, which results in an increase in cost.

### SUMMARY OF THE INVENTION

It is, therefore, an object of the present invention to provide an RGB color display apparatus capable of suppressing color temperature deviation or shift caused by variations in transmissivity of R, G, and B color filters while setting a common gradation level for R, G, and B color images.

It is another object of the invention to provide a semiconductor device for enabling the gradation setting of such RGB color display apparatus.

In accordance with one aspect of the invention, there is provided a display apparatus comprising:
a color display means;
a source driver and a gate driver for providing red (R), green (G), and blue (B) image data for displaying input image data on the color display means; and
a power supply circuit for supplying a power supply voltage to the source driver and/or gate driver, wherein the power supply voltage to be supplied to the source driver and/or gate driver is made variable at every predetermined output timing of the R, G, and B image data.

In accordance with another aspect of the invention, there is provided a display apparatus, comprising:
a color display means 10;
a gate driver 20 for supplying a gate voltage to the color display means;
a source driver 30 for supplying a source voltage to the color display means;
a control block (60 and 70) for supplying, upon receipt of a frame of color image data Dc that contains a synchronization signal, a predetermined timing signal for controlling the gate driver (the timing signal hereinafter referred to as gate driver controlling timing signal) tg to the gate driver, and supplying a predetermined timing signal for controlling the source driver (the timing signal hereinafter referred to as source driver controlling timing signal) ts and image data that include R, G, and B color image data to the source driver;
a gradation block 40 for generating and supplying a gradation voltage to the source driver; and
a power supply block (80 and 100) for supplying a power supply voltage to the source driver 30 and gradation block 40, wherein
the control block is adapted to:
   resolve one frame of color image data into a red-frame that consists of red image data Dr, a green-frame that consists of green image data Dg, and a blue-frame that consists of blue image data Db (the respective frames referred to as R, G, and B frame);
   sequentially supply the R, G, and B image data Dr, Dg, and Db, respectively, to the source driver at a predetermined time interval T2: and
   supply to the power supply block (80 and 100) a voltage controlling timing signal tp in synchronism with R, G, and B frames, and wherein
the power supply block generates, upon receipt of the voltage controlling timing signal tp, an R frame voltage Vr, a G frame voltage Vg, and a B frame voltage Vb for use as the power supply voltage for the respective R, G, and B frames.

The control block may have
a controller 60 for controlling image data and various kinds of timing signals, and
a buffer memory 70 for separately storing R image data Dr, G image data Dg, and B image data Db that constitute a color image data in such a way that the R image data Dr, G image data Dg, and B image data Db can be separately retrieved. The control block may be adapted to start supplying the R image data, G image data, and B image data to the source driver a predetermined time Tb after sending out the voltage controlling timing signal tp.

The power supply block may have:
a power supply circuit 100 for generating the power supply voltage, and
a storage unit 80 for storing, and delivering to the power supply circuit, output voltage data Dvr, Dvg, and Dvb that are respectively defined for the R, G, and B frames (the respective output voltage data referred to as R, G, and B output voltage data).

The storage unit 80 may be a programmable ROM capable of rewritably storing the R, G, and B output voltage data.

The power supply circuit may have:
registers 121, 122, and 123 for respectively storing the R, G, and B output voltage data (the registers respectively referred to as red-, green-, and blue-register, or in short, R, G, and B registers);
a selector 130 for sequentially retrieving from the R, G, and B registers the R, G, and B output voltage data associated with the voltage controlling timing signal tp, respectively, and for outputting the selected voltage as the reference voltage Vref to control the power supply voltage associated with the color frame; and
a voltage regulation circuit adapted to equilibrate the feedback voltage Vfb associated with the power supply voltage to the reference voltage Vref.

The selector 130 may have a counter 131 for counting the voltage controlling timing signal tp, and a logic circuit for outputting either one of the R, G, and B output voltage data in accord with the count of the counter.

A semiconductor device of the invention is formed to include the elements constituting the color display apparatus except for the color display means.

According to the invention, one frame of color image is resolved into R, G, and B frames, which are displayed in turn on the display apparatus. The power supply voltage is altered to preset voltage levels in synchronism with the R, G, and B frames. Thus, while setting a common gradation level for R, G, and B frames, deviation in color temperature caused by the variations in transmissivity of R, G, and B color filters can be suppressed.

As described above, supply of R, G, B image data to a color display means (for example, source driver of an LCD panel) is started when a predetermined delay time Tb has elapsed after sending out a voltage controlling timing signal tp. This circumvents supplying image data to the display means while voltage levels are changing, which adds stability to the image displayed.

It will be recalled that R output voltage data Dvr, G output voltage data Dvg, and B output voltage data Dvb defined for the R, G, and B frames, respectively, are stored in a storage device such as a programmable ROM, and that these output voltage data are supplied to the power supply circuit to serve as the reference voltages for the respective frames. Thus, color temperature deviation (or shift) can be alleviated by simply altering R, G, and B output voltage data in accord with the characteristic of the LCD panel in use, without changing the structure of the LCD panel. Moreover, given an LCD panel, its color temperature can be set by a user as he likes by simply altering the R, G, and B output voltage data, which is convenient for mass production of LCDs.

### BRIEF DESCRIPTION OF THE DRAWINGS

FIG. 1 shows a structure of an LCD according to the invention.

FIG. 2 shows a structure of a power supply block according to the invention.

FIG. 3 shows an arrangement of a selector for use in a power supply circuit according to the invention.

FIG. 4 is a timing diagram illustrating operation of an LCD of the invention.

### DETAILED DESCRIPTION OF THE PREFERRED EMBODIMENT

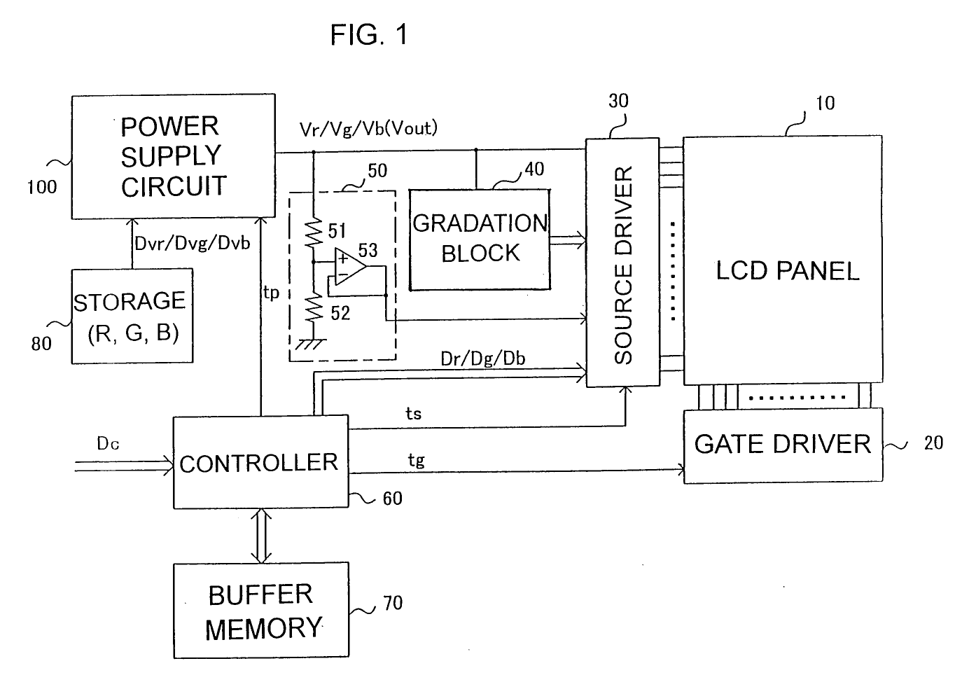

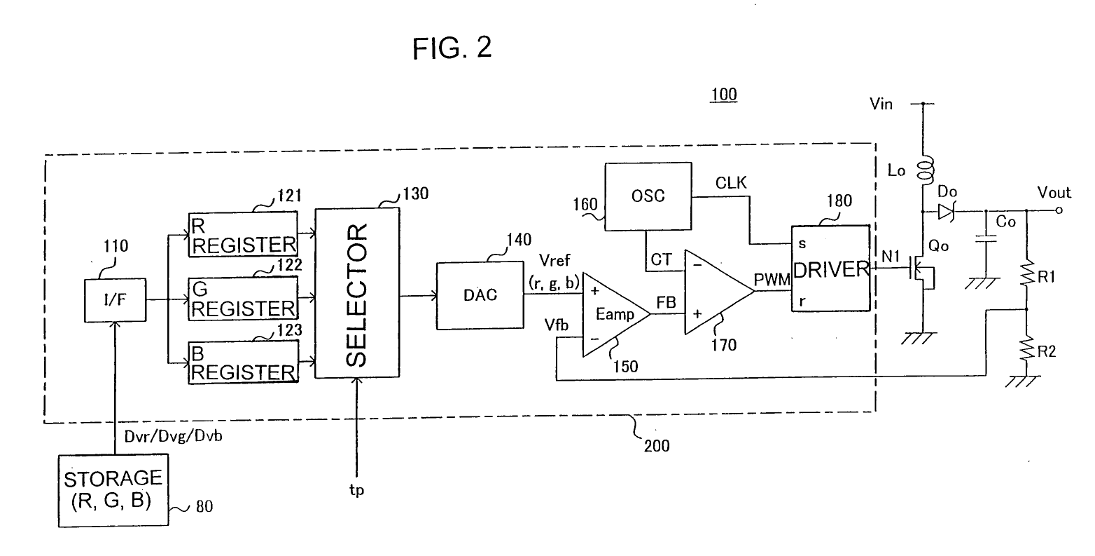

Preferred embodiments of a display apparatus and a semiconductor device therefor according to the invention will now be described in detail, with LCD as an example, and with reference to accompanying drawings. Referring to FIG. 1, there is shown a circuit arrangement of an LCD according to the invention. Elements of the LCD other than its LCD panel 10 are preferably fabricated in the form of semiconductor devices. FIG. 2 shows a circuit arrangement of a power supply block.

In the example shown in FIG. 1, the color LCD panel 10 can be, for example, an active-matrix type display apparatus utilizing thin film transistors (TFTs) arranged in a matrix configuration. A gate driver 20 supplies a gate voltage to the gates of the TFTs of the LCD panel 10. A source driver 30 provides a source voltage in accord with an image data to the sources (or drains) of the TFTs of the LCD panel 10.

A gradation block 40 generates a gradation voltage to be supplied to the source driver 30. A common voltage generation circuit 50 divides the power supply voltage by resistors 51 and 52 and provides one of the divided voltages via a buffer (voltage follower) as a common voltage for use in alternation driving of the LCD panel 10, and supplies it to the source driver 30.

The control block consists of a controller 60 and a buffer memory 70. This control block receives a frame of color image data Dc that contains a synchronization signal, and supplies a predetermined gate driver controlling timing signal tg to the gate driver 20, and provides a predetermined source driver controlling timing signal ts and image data Dr, Dg, and Db to the source driver 30.

The controller 60 separates one frame of color image data Dc into R, G, and B frames of R, G, and B image data, respectively. Each of the R, G, B frames of R, G, B image data is stored separately in the buffer memory 70.

The buffer memory 70 consists of a memory storage device such as an RAM. This buffer memory 70 is adapted to store color image data Dc in the form of separate R image data Dr, G image data Dg, and B image data Db, that can be retrieved in sequence as R, G, and B frames of R, G, B image data, respectively, at every predetermined time interval T2.

Since one frame of color image data Dc is separated into three R, G, and B frames of image data, which are displayed in sequence, the predetermined period T2 is ⅓ of the frame period T1 for one frame of color image data Dc.

The controller 60 provides the power supply block (80 and 100) with a voltage controlling timing signals tp synchronized to the R, G, and B frames.

The power supply block has a power supply circuit 100 for generating a power supply voltage, and a memory storage device 80 for storing predetermined R, G, and B output voltage data Dvr, Dvg, and Dvb, respectively, defined for the R, G, B frames, respectively, and supplies R, G, and B output voltage data to the power supply circuit 100. The power supply circuit 100 generates R, G, and B output voltages Vr, Vg, and Vb according to R, G, and B output voltage data Dvr, Dvg, and Dvb, respectively. These output voltages are, for example, Vr=9.1 V, Vg=9.0 V, and Vb=9.2 V.

The memory storage device 80 preferably consists of a programmable ROM, such as an EEPROM, that is capable of rewritably storing R, G, and B output voltage data Dvr, Dvg, and Dvb, respectively. Levels of these output voltage data Dvr, Dvg, and Dvb can be arbitrarily changed in accord with the preferred condition of the LCD panel, or by a user as needed.

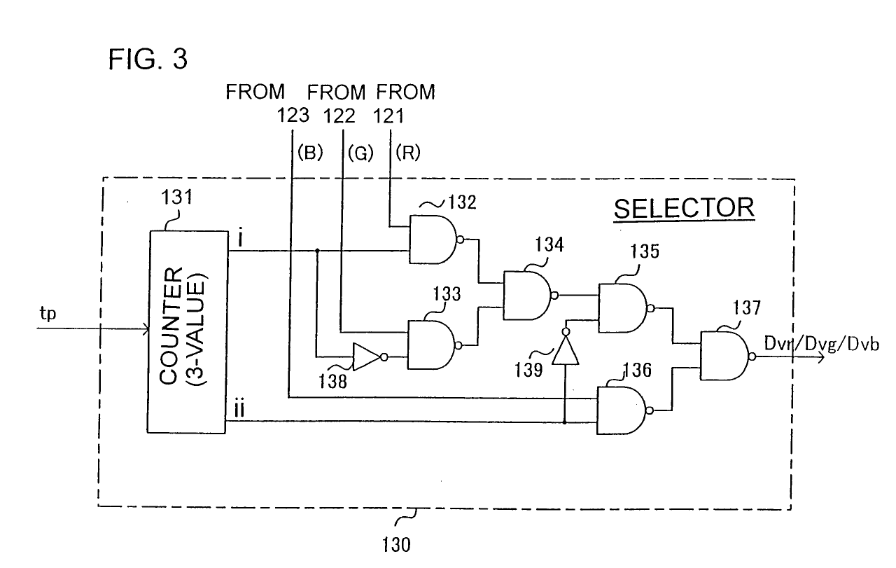

Referring to FIG. 2, there is shown an internal structure of the power supply circuit 100, along with the storage device 80. FIG. 3 shows an exemplary circuit arrangement of a selector for use in the power supply circuit 100.

In the example shown in FIG. 2, the power supply circuit 100 is a step-up switching power supply circuit. A coil Lo and a switching transistor Qo are connected in series between input voltage Vin and the ground. The voltage at the node of the series connection of the coil Lo and the switching transistor Qo is rectified and smoothed by a diode Do and a capacitor Co before it is output as output voltage Vout (Vr, Vg, Vb) from the power supply circuit.

An interface circuit (hereinafter referred to as I/F circuit) 110 receives R, G, B output voltage data Dvr, Dvg, Dvb, respectively, from the memory storage device 80 via, for example, a 3-way serial communications line. The I/F circuit 110 stores respective R, G, and B output voltage data Dvr, Dvg, and Dvb, respectively, in R, G, and B register 121, 122, and 123, respectively.

The selector 130 is fed R, G, B output voltage data Dvr, Dvg, and Dvb, respectively, from the R, G, B register 121, 122, and 123. One of these output voltage data Dvr, Dvg, and Dvb is selected and output every time a timing pulse of the timing signal tp is input. Output voltage data (Dvr, Dvg, Dvb) read out from the selector 130 corresponds to that (R, G, and B) frame read out from the buffer memory 70. This output voltage data (Dvr, Dvg, Dvb) is a digital signal.

A digital analog converter (DAC) 140 converts the output voltage data (Dvr, Dvg, Dvb) received from the selector 130 into an analog voltage. The analog output voltage of the DAC 140 serves as reference voltage Vref to obtain predetermined power supply voltage Vout (Vr, Vg, Vb).

An exemplary circuit arrangement of the selector 130 is shown in FIG. 3. As seen in FIG. 3, a counter 131 is a 3-value repeat counter that counts up every time a timing pulse of the timing signal tp is input. The counter is reset to an initial value by, for example, a synchronization signal contained in the color image data Dc. This synchronization signal is easily obtained from the controller 60. By the synchronization signal, correspondence is established between output voltage data (Dvr, Dvg, and Dvb) and the associated (R, G, and B) frame read out from the buffer memory 70.

R, G, and B output voltage data Dvr, Dvg, and Dvb, respectively, are also input into the logic circuits (which are NAND circuits 132-137 and NOT circuits 138-139 in the example shown in FIG. 3) of the selector circuit 130. This selector circuit 130 outputs either one of R, G, and B output voltage data Dvr, Dvg, and Dvb, respectively, according to the count of the counter 131.

In the example shown in FIG. 3, R output voltage data Dvr is selected when the output levels of the output ends i and ii of the counter 131 are respectively high (H) and low (L); G output voltage data Dvg is selected when the output levels of the output ends i and ii are low (L); and B output voltage data Dvb is selected when the output levels of the output ends i and ii are respectively low (L) and high (H).

Referring back to FIG. 2, an error amplifier 150 outputs a difference signal FB indicative of the difference between reference voltage Vref and feedback voltage Vfb that is obtained by dividing power supply voltage Vout by resistors R1 and R2. A PWM comparator 170 provides a pulse width modulation signal PWM by comparing the difference signal FB with a triangular wave signal CT received from an oscillating circuit 160. A driver 180 provides a gate control signal N1 to a switching transistor Qo based on the pulse width modulation signal PWM and the clock signal CLK received from the oscillating circuit 160. These feedback control loops are adapted to equilibrate feedback voltage Vfb to reference voltage Vref so as to hold power supply voltage Vout at a predetermined level.

The section of the power supply circuit 100, subsequent to the error amplifier 150, providing output voltage Vout, constitutes a voltage regulation circuit. The voltage regulation circuit can be of any configuration so long as it can provide output voltage Vout in accord with given reference voltage Vref. Thus, it should be understood that the circuit arrangement shown in FIG. 2 is intended to be illustrative of an inventive voltage regulation circuit.

Reference numeral 200 of FIG. 2 represents an IC chip that incorporates a portion of the power supply circuits 100 that serves as the control circuit thereof. It is noted that the operation of the control circuit portion incorporated in the IC chip 200 is independent of the magnitudes of the output current or output voltage, and that it can be manufactured separately from an erasable memory storage such as an EEPROM. Therefore, the IC chip 200 can be used as a general-purpose control IC chip for a variety of LCDs.

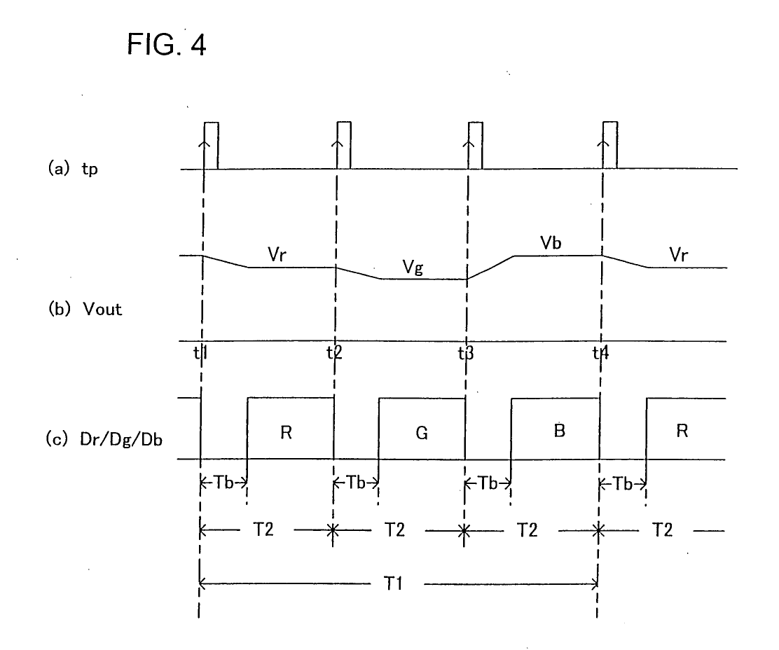

Operation of the LCD of the invention, as configured above, will now be described with reference to the timing diagram shown in FIG. 4.

In the present invention, one frame of full-color image data Dc is resolved into three R, G, and B frames to be displayed in sequence. This implies that, given a frame rate for one full-color image being 60 (or 75) frames/sec, one full-color image is resolved into 180 (or 225) frames of three primary (R, G, and B) color images, that will be displayed at the frame rate of 180 (or 225) frames/sec according to the invention. That is, as shown in FIG. 4, one frame period T2 of the invention for one primary color image is ⅓ of one frame period T1 for one frame of full-color image.

It is seen in FIG. 4 that one frame period for R image (referred to as R frame period) starts when a pulse of the timing signal tp is issued at time t1. Time t1 is the beginning of the frame period T1 for one (frame of) full-color image. That is, it corresponds to a frame synchronization timing of the power supply circuit 100, or more particularly, of the selector 130 of FIG. 2. Therefore, R image data is read out from the buffer memory 70 at time t1, and at the same time R output voltage Vr associated with R output voltage data Dvr is output from the power supply circuit 100.

However, the power supply circuit 100 has a certain delay time between reception of output voltage data (Dvr for example) and generation of a predetermined output voltage associated therewith (Vr in this example). Thus, during the delay time, the power supply circuit 100 fails to provide a valid output voltage to properly display the data.

Therefore, it is preferable for R image data to be read out after power supply voltage Vout has reached predetermined power supply voltage Vr. To do this, a blanking period is provided starting at time t1 and lasting a predetermined delay time Tb. This blanking period Tb equals a time interval necessary for power supply voltage Vout to grow up to predetermined power supply voltage Vr. Thus, R image data is read out after expiration of the blanking period Tb.

At time t2, G image data can be read out from the buffer memory 70, when G output voltage Vg is provided from the power supply circuit 100 in accord with G output voltage data Dvg. Similarly, at time t3, B image data can be read out from the buffer memory 70 and B output voltage Vb is provided from the power supply circuit 100 in accord with B output voltage data Dvb.

At time t4, the next frame of full-color image is started, for which a similar procedure to the one as described above is repeated.

The invention enables suppression of color temperature deviation or shift caused by variations in transmissivity of color filters while setting a common gradation level for R, G, and B colors.

It should be appreciated that color temperature deviation can be alleviated, without changing the structure of the LCD, by simply rewriting R, G, B output voltage data Dvr, Dvg, and Dvb, respectively. Moreover, the color temperature of a given LCD panel can be set by a user as needed.

Although the power supply circuit has been described with reference to a step-up switching power supply circuit as shown in FIG. 2, a step-down switching power supply circuit, a series type power supply circuit, and other types of power supply circuit can be alternatively used.

1. A display apparatus, comprising:
a color display means;
a source driver and a gate driver for providing red, green, and blue image data for displaying input image data on said color display means; and
a power supply circuit for supplying a power supply voltage to said source driver and/or gate driver, wherein said power supply voltage to be supplied to said source driver and/or gate driver is made variable at every predetermined output timing of said red, green, and blue image data.

2. A display apparatus, comprising:
a color display means;
a gate driver for supplying a gate voltage to said color display means;
a source driver for supplying a source voltage to said color display means;
a control block for supplying, upon receipt of a frame of color image data that contains a synchronization signal, a predetermined gate driver controlling timing signal to said gate driver, and supplying a predetermined source driver controlling timing signal and image data that include red-, green-, and blue-color image data to said source driver;
a gradation block for generating a gradation voltage and supplying said gradation voltage to said source driver; and
a power supply block for supplying a power supply voltage to said source driver and gradation block, wherein
said control block is adapted to:
resolve said frame of color image data into a red-frame that consists of red image data, a green-frame that consists of green image data, and a blue-frame that consists of blue image data;
sequentially supply said red, green, and blue image data to said source driver at a predetermined time interval: and
supply to said power supply block a voltage controlling timing signal in synchronism with said red-, green-, and blue-frame, and wherein
said power supply block generates, upon receipt of said voltage controlling timing signal, an red-frame voltage, a green-frame voltage, and a blue-frame voltage for use as the power supply voltage for the respective red-, green-, and blue-frames.

3. The display apparatus according to claim 2, wherein:
said control block has
a controller for controlling image data and various kinds of timing signals, and
a buffer memory for separately storing red, green, and blue image data of a color image data such that said red, green, and blue image data is separately retrievable; and
said control block is adapted to start supplying said red, green, and blue image data to said source driver a predetermined time after sending out the voltage controlling timing signal.

4. The display apparatus according to claim 2, wherein said power supply block has
a power supply circuit for generating said power supply voltage, and
a storage unit for storing, and delivering to said power supply circuit, red-, green-, and blue-output voltage data that are de fine d for the red-, green-, and blue-frame, respectively.

5. The display apparatus according to claim 4, wherein said storage unit is a programmable ROM capable of rewritably storing the red-, green-, and blue-output voltage data.

6. The display apparatus according to claim 4, wherein said power supply circuit has:
a red-register for storing said red output voltage data;
a green-register for storing said green output voltage data;
a blue-register for storing said blue output voltage data;
a selector for sequentially retrieving from the red-, green-, and blue-registers the red-, green-, and blue-output voltage data associated with said voltage controlling timing signal, respectively, and for outputting the selected voltage as the reference voltage to control the power supply voltage associated with the color frame; and
a voltage regulation circuit adapted to equilibrate the feedback voltage associated with said power supply voltage to said reference voltage.

7. The display apparatus according to claim 6, wherein said selector has
a counter for counting said voltage controlling timing signal, and
a logic circuit for outputting either one of said red-, green-, and blue-output voltage data in accord with the count of the counter.

8. A semiconductor device, comprising:
a source driver and a gate driver for providing red, green, and blue image data for displaying input image data on a color display means; and
a power supply circuit for supplying a power supply voltage to said source driver and/or gate driver, wherein
said power supply voltage to be supplied to said source driver and/or gate driver is made variable at every predetermined output timing of said red, green, and blue image data.

9. A semiconductor device, comprising:
a gate driver for supplying a gate voltage to a color display means;
a source driver for supplying a source voltage to said color display means;
a control block for supplying, upon receipt of a frame of color image data that contains a synchronization signal, a predetermined gate driver controlling timing signal to said gate driver, and supplying a predetermined source driver controlling timing signal and image data that include red-, green-, and blue-color image data to the source driver;
a gradation block for generating a gradation voltage and supplying said gradation voltage to said source driver; and
a power supply block for supplying a power supply voltage to said source driver and gradation block, wherein
said control block is adapted to:
resolve one frame of color image data into a red-frame that consists of red image data, a green-frame that consists of green image data, and a blue-frame that consists of blue image data;
sequentially supply said red, green, and blue image data to said source driver at a predetermined time interval: and
supply to said power supply block a voltage controlling timing signal in synchronism with red-, green-, and blue-frame, and wherein,
said power supply block generates, upon receipt of said voltage controlling timing signal, an red-frame voltage, a green-frame voltage, and a blue-frame voltage for use as the power supply voltage for the respective red-, green-, and blue-frames.

10. The semiconductor device according to claim 9, wherein
said control block has
a controller for controlling image data and various kinds of timing signals, and
a buffer memory for separately storing red, green, and blue image data of a color image data such that said red, green, and blue image data is separately retrievable; and
said control block is adapted to start supplying said red, green, and blue image data to said source driver a predetermined time after sending out the voltage controlling timing signal.

11. The semiconductor device according to claim 9, wherein said power supply blocks has
a power supply circuit for generating said power supply voltage, and
a storage unit for storing, and delivering to said power supply circuit, red-, green-, and blue-output voltage data that are defined for the red-, green-, and blue-frame, respectively.

12. The semiconductor device according to claim 11, wherein said storage unit is a programmable ROM capable of rewritably storing the red-, green-, and blue-output voltage data.

13. The semiconductor device according to claim 11, wherein said power supply circuit has:
a red-register for storing said red output voltage data;
a green-register for storing said green output voltage data;
a blue-register for storing said blue output voltage data;
a selector for sequentially selecting said red-, green-, and blue-output voltage data, stored in said red-, green-, and blue-registers, respectively, and for outputting the selected voltage as the reference voltage to control said power supply voltage; and
a voltage regulation circuit adapted to equilibrate the feedback voltage associated with said power supply voltage to said reference voltage.

14. The semiconductor device according to claim 13, wherein said selector has
a counter for counting said voltage controlling timing signal, and
a logic circuit for outputting either one of said red-, green-, and blue-output voltage data in accord with the count of the counter.
